(19) United States
(12) Patent Application Publication
(10) Pub. No.: US 2013/0329681 A1
(43) Pub. Date: Dec. 12, 2013

(54) Method and Apparatus

(71) Applicant: Benoist Pierre Sebire, Tokyo (JP)

(72) Inventor: Benoist Pierre Sebire, Tokyo (JP)

(73) Assignee: NOkia Siemens Networks Oy, Espoo (FI)

(21) Appl. No.: 13/978,921

(22) PCT Filed: Jan. 10, 2011
(86) PCT No.: PCT/EP11/50208

§ 371 Date: Aug. 22, 2013

(51) Int. Cl. H04W 72/02

(52) U.S. Cl. CPC H04W 72/02
USPC 370/329; 370/328

(57) ABSTRACT

A method includes determining an unscheduled period in which a user equipment is configured to utilise a radio frequency different to a wireless cellular communication and providing a message including length information indicating a length of said unscheduled period.

Embodiments relate to a method and apparatus where a user equipment suffers coexistence interference.

Communication between two or more entities such as mobile communication devices and other stations can be facilitated by a communication system. A communication system and compatible communication devices typically operate in accordance with a given standard or specification which sets out what the various entities associated with the system are permitted to do and how that should be achieved. For example, the manner how the communication device can access the communication system and how communications shall be implemented between communicating devices, the elements of the communication network and/or other communication devices is typically defined.

In a wireless communication system at least a part of communications between at least two stations occurs over a wireless link. In wireless systems a communication device thus typically provides a transceiver station that can communicate with the access node and/or another communications device. Examples of wireless systems include public land mobile networks (PLMN), satellite based communication systems and different wireless local networks, for example wireless local area networks (WLAN). In wireless systems an access node is provided by a base station. The radio coverage area of a base station is known as a cell, and therefore the wireless systems are often referred to as cellular systems. In some systems a base station access node is called Node B.

A communication system can be accessed by means of an appropriate communication device. A communication device of a user is often referred to as user equipment (UE). A communication device is provided with an appropriate signal receiving and transmitting arrangement for enabling communications with other parties. A feature of wireless communication devices is that they offer mobility for the users thereof. A mobile communication device, or mobile device for short, may also be transferred, or handed over, from a base station to another and even between base stations belonging to different systems.

According to one embodiment, there is a method comprising: determining an unscheduled period in which a user equipment is configured to utilise a radio frequency different to a wireless cellular communication; and providing a message comprising length information indicating a length of said unscheduled period.

The message may comprise a media access control control element providing said length information.

The length information may comprise a number of subframes.

The length information may identify one of a plurality of predefined lengths.

The length information may comprise timer information.

The method may comprise starting a timer for a period of time corresponding to said timer information.

The method may comprise ending said unscheduled period at the end of said time period.

The message may comprise a request for said unscheduled period.

The method may comprise starting said unscheduled period responsive to information granting said request.

The information granting said request may comprise at least part of said message.

The message may comprise a notification for said unscheduled period.

The method may comprise providing a message comprising timing information about when said unscheduled period occurs.

The timing information may comprise start time information.

The start time information may comprise a system frame number.

The length information and said timing information may be provided in a same message.

The message may comprise cell information, in the case of carrier aggregation, indicating cells to which said unscheduled period applies.

The cell information may comprise a bitmap.

The different frequency may comprise an industrial, scientific and medical frequency or a global navigation frequency.

The method may be performed in one of said user equipment and a wireless access node.

According to a second embodiment, there is provided an apparatus comprising at least one processor, and at least one memory including computer program code, wherein the at least one memory and the computer program code are configured, with the at least one processor, to: determine an unscheduled period in which a user equipment is configured to utilise a radio frequency different to a wireless cellular communication; and provide a message comprising length information indicating a length of said unscheduled period.

The message may comprise a media access control control element providing said length information.

The length information may comprise a number of subframes.

The length information may identify one of a plurality of predefined lengths.

The length information may comprise timer information.

The at least one memory and the computer program code may be configured, with the at least one processor, to start a timer for a period of time corresponding to said timer information.

The at least one memory and the computer program code may be configured, with the at least one processor, to end said unscheduled period at the end of said time period.

The message may comprise a request for said unscheduled period.

The at least one memory and the computer program code may be configured, with the at least one processor, to start said unscheduled period responsive to information granting said request.

The information granting said request may comprise at least part of said message.

The message may comprise a notification for said unscheduled period.

The at least one memory and the computer program code may be configured, with the at least one processor, to provide a message comprising timing information about when said unscheduled period occurs.

The timing information may comprise start time information.

The start time information may comprise a system frame number.

The length information and said timing information may be provided in a same message.

The message may comprise cell information, in the case of carrier aggregation, indicating cells to which said unscheduled period applies.

The cell information may comprise a bitmap.

The different frequency may comprise an industrial, scientific and medical frequency or a global navigation frequency.

According to another embodiment a user equipment or a base station may comprise the apparatus as described above.

A computer program comprising program code means adapted to perform the herein described methods may also be provided. In accordance with further embodiments apparatus and/or computer program product that can be embodied on a computer readable medium for providing at least one of the above methods may be provided.

Various other aspects and further embodiments are also described in the following detailed description of examples and in the attached claims.

For a better understanding of some embodiments of the invention, reference will be made by way of example only to the accompanying drawings in which:

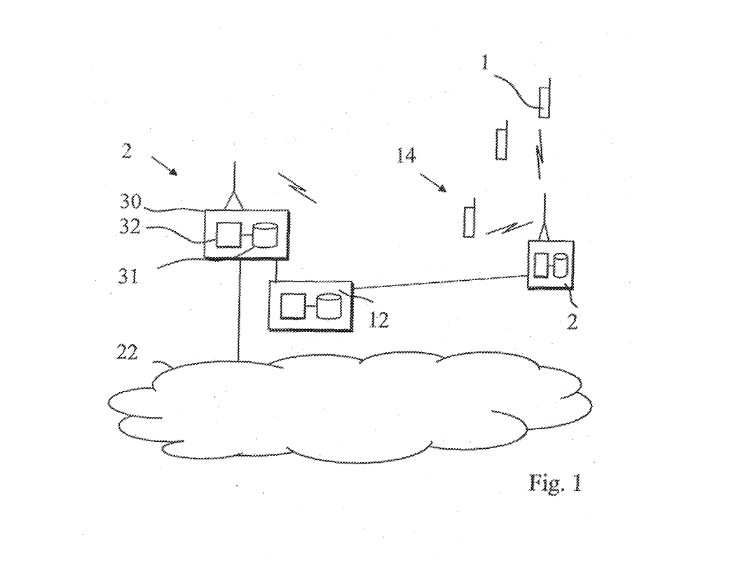

FIG. 1 schematically shows part of a communications network;

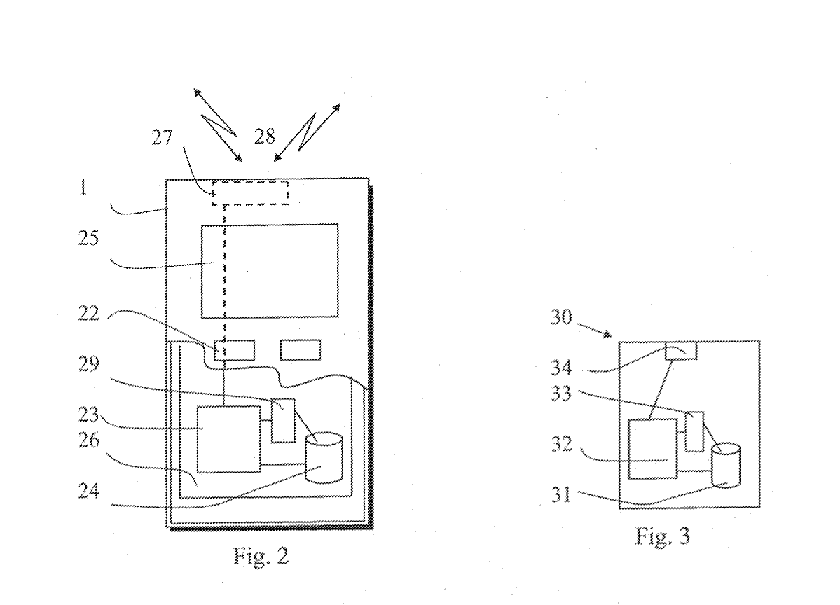

FIG. 2 shows an example of a communication device;

FIG. 3 shows an example of controller apparatus for a base station;

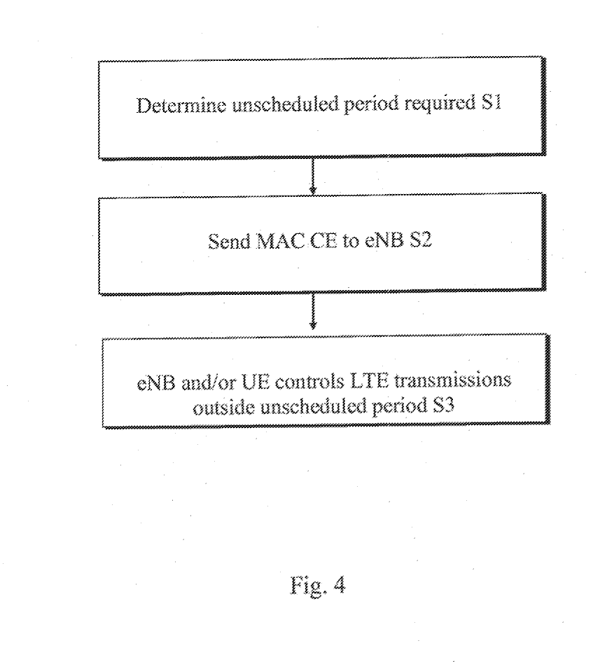

FIG. 4 is flowchart illustrating an embodiment;

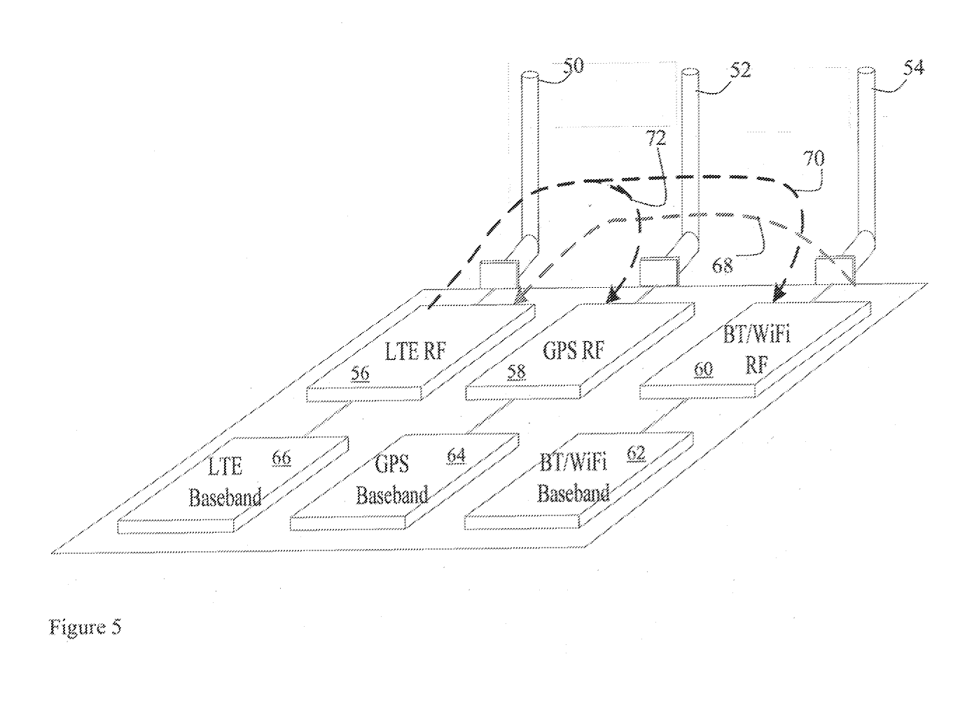

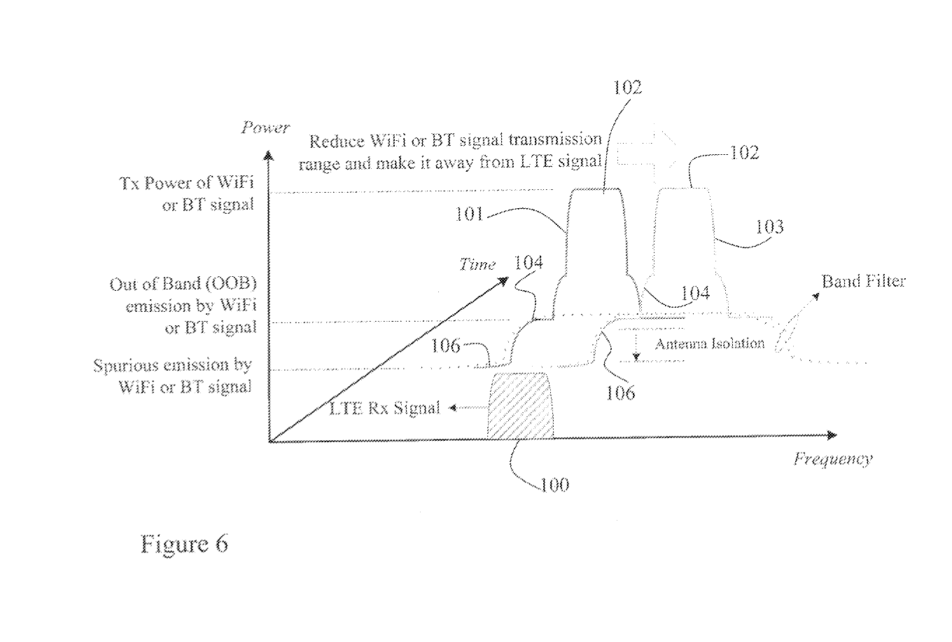

FIG. 5 shows a communication device with three transceivers;

FIG. 6 shows schematically a frequency division multiplexing (FDM) approach to co-existence interference; and

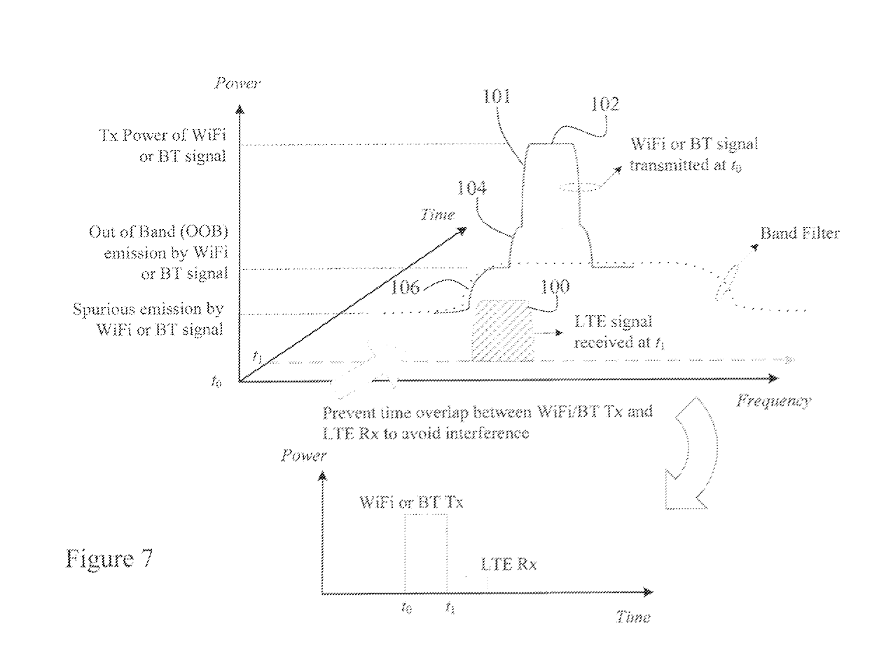

FIG. 7 shows schematically a time division multiplexing (TDM) solution to co-existence interference.

In the following certain exemplifying embodiments are explained with reference to wireless or mobile communication systems serving mobile communication devices. Before explaining in detail the certain exemplifying embodiments, certain general principles of a wireless communication system and the nodes thereof are briefly explained with reference to FIGS. 1 to 3 to assist in understanding of the herein described embodiments.

In a mobile system a user can be provided with a mobile communication device 1 that can be used for accessing various services and/or applications. The access can be provided via an access interface between the mobile user device 1 and an appropriate wireless access system, for example an access node. An access node can be provided by a base station. FIG. 1 shows part of a radio access network (RAN), including a first base station 2 and a second base station 2. The term base station will be used in the following and is intended to include the use of any of these access nodes or any other suitable access node. The base stations each have a cell associated therewith. The access system also comprises a mobility management entity (MME) 12. The mobile management entity 12 and the base stations can be connected, for example, by means of a S1 interface.

Although not shown, a gateway function between the access systems, a core network 22 and/or another network such as the packet data network may also be provided by means of appropriate gateway nodes. Regardless of the gateway arrangement, a communication device can be connected to an external data network, for example the internet via the access nodes and the base station.

The mobile communication devices can access the communication system based on various access techniques, such as code division multiple access (CDMA), or wideband CDMA (WCDMA), the latter technique being used by some communication systems based on the third Generation Partnership Project (3GPP) specifications. For LTE (long term evolution) and LTE-A (long term evolution-advanced), OFDMA (Orthogonal Frequency Division Multiplexing) in the DL (down link) and single-carrier FDMA in the UL (uplink) can be used. Other examples include time division multiple access (TDMA), frequency division multiple access (FDMA), space division multiple access (SDMA) and so on. In a wireless system a network entity such as a base station provides an access node for communication devices.

A non-limiting example of mobile architectures where the herein described principles may be applied is known as the Evolved Universal Terrestrial Radio Access Network (E-UTRAN). Non-limiting examples of appropriate access nodes are a base station of such system, for example what is known as NodeB (NB) or enhanced NodeB (eNB) in the vocabulary of the 3GPP specifications. Other examples include base stations of systems that are based on technologies such as wireless local area network (WLAN) and/or WiMax (Worldwide Interoperability for Microwave Access). Access nodes can provide cellular system level base stations providing E-UTRAN features such as user plane Radio Link Control/Medium Access Control/Physical layer protocol (RLC/MAC/PHY) and control plane Radio Resource Control (RRC) protocol terminations towards mobile communication devices.

Regardless of the underlying standard, a mobile communication device can be provided wireless access via at least one base station or similar wireless transceiver node of an access system. An access system may be provided by a cell of a cellular system or another radio service area enabling a communication device to access a communication system. Therefore an access system is hereinafter referred to as a radio service area or cell. Typically a cell is provided by a base station site. A base station site can provide a plurality of sectors, for example three radio sectors, each sector providing a cell or a sub radio service area of a cell.

FIG. 2 shows a schematic, partially sectioned view of a communication device 1 that a user can use for communication. Such a communication device is often referred to as user equipment (UE) or terminal. An appropriate mobile communication device may be provided by any device capable of sending and receiving radio signals. Non-limiting examples include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. User may also be provided broadcast or multicast data. Non-limiting examples of the content include downloads, television and radio programs, videos, advertisements, various alerts and other information.

The mobile communication device 1 may receive and transmit signals over an air interface 28 via appropriate apparatus for receiving and transmitting signals. In FIG. 2 transceiver apparatus is designated schematically by block 27. The transceiver may be provided for example by means of a radio part and associated antenna arrangement. The antenna arrangement may be arranged internally or externally to the mobile device.

A mobile communication device is also typically provided with at least one data processing entity 23, at least one memory 24 and other possible components 29 for use in software and hardware aided execution of tasks it is designed to perform, including control of access to and communications with base stations and other communication devices. The data processing, storage and other relevant control apparatus can be provided on an appropriate circuit board and/or in chipsets. This feature is denoted by reference 26. Possible control functions in view of configuring the mobile communication device for reception and/or transmission of signalling information and data by means of the data processing facility in accordance with certain embodiments of the present invention will be described later in this description.

The user may control the operation of a communication device by means of a suitable user interface such as keypad 22, voice commands, touch sensitive screen or pad, combinations thereof or the like. A display 25, a speaker and a microphone are also typically provided. Furthermore, a mobile communication device may comprise appropriate connectors (either wired or wireless) to other devices and/or for connecting external accessories, for example hands-free equipment, thereto.

FIG. 3 shows an example of a control apparatus 30, for example to be coupled to a base station and/or part of the base station itself. The control apparatus 30 can be arranged to provide control on use of resources for communications by mobile communication devices that are in the service area. The control apparatus 30 can be configured to provide control functions in association with generation and communication of resource allocation information and other related information and for coordination of resource allocation for signalling and data communications by means of the data processing facility in accordance with certain embodiments described below. For this purpose the control apparatus 30 comprises at least one memory 31, at least one data processing unit 32, 33 and an input/output interface 34. Via the interface the control apparatus can be coupled to receiver and transmitter apparatus of a base station. The control apparatus 30 can be configured to execute an appropriate software code to provide the control functions.

Reference is made to FIG. 5 which shows part of the device 1 in more detail. In this example, the device 1 has a first antenna 50, a second antenna 52 and a third antenna 54. The first antenna 50 is configured to transmit and receive LTE signals. The second antenna 52 is configured to receive GPS (global positioning system) signals. The third antenna 54 is configured to transmit and receive Bluetooth and/or Wi-Fi signals. These latter signals are referred to as ISM (industrial, scientific and medical) signals. This is in order to allow the device to access various networks and services.

The first antenna 50 is connected to an LTE radio frequency processor 56 which is arranged to process the radio frequency signals. The LTE radio frequency processor 56 is coupled to an LTE baseband processor 66 which is arranged to process the radio frequency signals to convert those signals to the baseband and to process those signals. Similarly, the second antenna 52 is coupled to a GPS radio frequency processor 58, which is arranged to be coupled to the GPS baseband processor 64. Finally, the third antenna 54 is connected to a Bluetooth/Wi-Fi radio frequency processor 60 which in turn is connected to the Bluetooth/Wi-Fi baseband processor 62. It should be appreciated that when the respective antenna receives a radio frequency signal, that radio frequency signal is provided to the respective radio frequency processor. The radio frequency processor may carry out any suitable processes, for example, filtering the desired signal from the undesired signals and/or amplification. The processed radio frequency signal is then provided to the respective baseband processor for down-conversion to the baseband and further processing.

In the case of transmission, the baseband processors will receive the signals at the baseband and up-convert those signals to the radio frequency. Other processing may be carried out by the baseband processors. Those radio frequency signals are then passed to the respective radio frequency processor.

The processing carried out by the respective blocks can be performed by a single block or processor, or by more than two blocks or processors. The division of the processes between the blocks can of course be changed. For example, the RF processing block may, for example, in some embodiments perform the baseband conversion, at least one of converting down to the baseband or up-converting to the radio frequency. Separate processors and/or antennas may be provided in some embodiments for uplink and downlink. In some embodiments, at least one processor may be used for two or more different types of signal received from and/or to be transmitted by two or more antennas.

It should be appreciated that in some embodiments, the GPS blocks may only need to receive signals.

It is possible that when LTE and ISM (which includes Bluetooth and WLAN technology) capabilities are provided in a single device, the LTE and ISM radio within the same device may be working on adjacent frequencies. For example, the LTE may be working on the upper part of band 40 (2300-2400 MHz) and the ISM may be working in the example 2450 MHz band. This type of coexistence may cause interference. In some scenarios, the filtering technology is such that it is difficult to provide a terminal filter with sufficient rejection on the adjacent frequencies. This interference between the LTE frequencies and the Bluetooth/Wi-Fi frequencies is schematically shown in FIG. 5 by arrows 68 and 70.

With the rapid increase in the number and types of GPS systems, such as GPS, A-GPS (assisted global navigation satellite system) and COMPASS, the spectrum allocation to the services is increasing. When LTE and GPS radio capabilities are provided within the same device, this may cause interference due to the adjacent operation or harmonics. This may be difficult to avoid with the allocation of a guard band at the sub-harmonic frequency. It has been suggested that the guard band requires double the GPS carrier bandwidth which may impact on large GPS bandwidth systems particularly such as AGNSS and COMPASS as well GPS. The interference between the LTE and GPS systems is schematically shown by arrow 72 in FIG. 5.

Reference is made to the 3GPP specification 36.816 which has the objective to investigate suitable mechanisms for facilitating the coexistence scenario that LTE and GPS/ISM radio are within the same device working in adjacent frequencies or sub-harmonic frequencies.

Currently, some mechanisms have been suggested in LTE which could be utilised to detect and avoid interference such as RSRQ (reference signal received quality) measurement, interfrequency/inter-RAT (radio access technology) handover, cell selection or reselection, RLF (Radio Link Failure) monitoring and connection reestablishment.

Thus, in a communication device which is necessarily small, the different radio transceivers are arranged relatively close to one another. Accordingly, the transmit power of one transmitter may be much higher than the received power of another receiver. Generally, by means of filter technologies and sufficient frequency separation, the transmit signal may not result in significant interference to a received signal. However, for some of the coexistence scenarios where different radio technologies are supported within the same user equipment and operating on adjacent frequencies, current filter technology might not provide sufficient rejection. In some UEs, a single generic RF design may be used. However, in some scenarios, alternative methods are used.

In some embodiments, the communication device in the case of LTE interference will be aware of the cause of the interference. In other words, the communication device will know that the activation of the ISM and/or GPS device is the source of the interference. Accordingly, in some embodiments, the communication device is able to use this information in order to mitigate or avoid the interference.

In some embodiments, the scenarios where in-device coexistence interference can cause problems are well defined:

Case 1: LTE band 40 radio transmission (2300-2400 MHz) causing interference to ISM radio reception (Bluetooth-2450 MHz and IEEE 802.11/Wi-Fi-2450 MHz).

Case 2: ISM radio transmission causing interference to LTE band 40 radio reception (the relevant frequencies are as in Case 1).

Case 3: LTE band 7 (2500 MHz-2570 MHz) radio transmission causing interference to ISM radio reception at the frequencies mentioned previously.

Case 4: The user equipment is transmitting on LTE band 7, 13 or 14. As mentioned previously, band 7 is 2500 MHz to 2570 MHz, band 13 is 777 MHz to 787 MHz and band 14 is 788 MHz to 798 MHz. This may cause interference to the GNSS radio reception. Depending on the satellite system, the frequency ranges are from about 1.2 GHz to about 1.6 GHz. Typically, the interference will be cause by frequency harmonics.

It has been proposed that the user equipment inform the E- UTRAN when transmission/reception of LTE and/or other radio signals would benefit or no longer benefit from LTE not using certain carriers or frequency resources. The user equipment judgement may be taken as a baseline approach for frequency domain multiplexing where the user equipment indicates which frequencies are and/or not usable due to in-device interference.

In response to such signalling, an eNodeB would typically order the user equipment to perform a handover to a frequency that has not been reported by the UE as suffering from in-device coexistence interference. This is referred to as an FDM solution. Alternatively or additionally, a TDM solution may be used where scheduled and unscheduled periods are alternated on problematic frequencies.

Reference is made to FIG. 6 which shows schematically the FDM approach. FIG. 6 shows a graph of power against frequency. The LTE RX or received signal is referenced 100. The initial Wi-Fi or Bluetooth signal which is initially scheduled for transmission is referenced 101. As can be seen, the transmit power of the Wi-Fi or Bluetooth signal is very much greater than the power of the received LTE signal. The Wi-Fi or Bluetooth signal has a main part of the signal 102 (the in band signal), an out of band emission and a spurious emission which are respectively referenced 104 and 106. As can be seen from FIG. 6, whilst the main part 102 of the Wi-Fi or Bluetooth signal does not overlap the frequency of the LTE RX signal, there is overlap between the out of band emission 104 as well as the spurious emission. Both the out of band emission and the spurious emission have power levels which are greater than that of the received signal.

The FDM solution moves the signal 101 in frequency so that the Wi-Fi or Bluetooth signal is now at a higher frequency. Those parts of the signal which correspond generally to those of signal 101 are referenced with the same reference number. Accordingly, the moved signal 103 has a main transmission part 102, an out of band emission part 104 and a spurious emission part 106. As can be seen from FIG. 6, the overlap between the LTE RX signal and the spurious emissions and out of band emissions have been removed because of the greater frequency separation. Thus, in the arrangement shown in FIG. 6, the ISM radio signal is led away from the LTE frequency band in the frequency domain. In order to assist the ISM radio to complete the necessary procedure to enable this option, the LTE arrangement may also need to avoid any coexistence interference to the ISM radio during the initial stage.

Reference is now made to FIG. 7 which shows the TDM solution. This solution is arranged to ensure that the transmission of the ISM radio signal does not coincide with the reception of the LTE radio signal. FIG. 7 also shows a graph of power versus frequency. The graph shows the same LTE RX signal 100 and the ISM transmission signal 101, as shown in FIG. 6. As illustrated schematically in FIG. 7 which also shows a graph of power versus time, the Wi-Fi or BT TX signal is scheduled for time t0 whilst the LTE RX signal is scheduled for reception at time t1. Thus, time overlap between the WiFi/BT transmission and the LTE reception is prevented, to avoid interference.

For the TDM solution, one approach is that the user equipment suggests the timing pattern to the eNodeB and it is up to the eNodeB to decide the final TDM pattern. However, it should be appreciated that the eNodeB may decide the pattern or the user equipment may decide the pattern.

In one embodiment, in order for the user equipment to request an unscheduled period, a MAC CE (media access control control element) conveying the length of the unscheduled period is sent from the user equipment to the eNodeB. The length can be expressed in any suitable form. For example, the length can be expressed in terms of number of sub-frames or may refer to one of a plurality of predefined lengths which are preset between the user equipment and the eNodeB.

The MAC CE is sent as part of a MAC packet data unit (PDU) which comprises a MAC packet header, zero or more MAC service data units (SDU) and one or more MAC control elements.

In one embodiment the uplink, the MAC CE is sent to request an unscheduled period. In the downlink situation, that MAC CE may be used to order an unscheduled period.

In one embodiment, if the user equipment can take the decision autonomously, then the MAC CE may only be required in the uplink to notify the eNodeB of an upcoming unscheduled period.

In one embodiment, the MAC CE may also be used to convey the point in time where the unscheduled period is requested and/or starts. . Without the start time information, the UE or eNB does not know with certainty when the unscheduled period starts as it depends on HARQ performance, ACK/NAK errors and UE processing delays. In some embodiments, the start time is explicitly signalled, so there is no ambiguity.

This information can take any suitable form number and may be, for example the SFN (System Frame Number). It should be appreciated that the point in time where the unscheduled period is requested and/or starts may be sent in a separate control element to the control element conveying the length of the unscheduled period. Alternatively the information can be sent together. This information can be provided at the same time in which the unscheduled period is requested and/or at a different time.

The unscheduled period is the period during which the LTE UE is not scheduled to transmit or receive, thereby allowing for example the ISM radio to operate without interference. The scheduling period is the period is the period during which the LTE UE may be scheduled to transmit or receive.

In the case of carrier aggregation, the MAC CE may also include a bit map listing cells to which the unscheduled period applies. It is expected that in the case of carrier aggregation, not all serving cells will suffer from in-device coexistence interference. Carrier aggregation is where a plurality of carriers are aggregated to increase bandwidth. Carrier aggregation comprises aggregating a plurality of component carriers into a carrier that is referred to generally as an aggregated carrier.

Reference is made to FIG. 4 which shows a method of an embodiment. In step S1, a determination that an unscheduled period is required is made. This may be made by the UE, by the eNB or by the UE and the eNB.

In step S2, the MAC CE with the length of the unscheduled period and optionally the start information is sent from the UE to the eNB. In an alternative embodiment, this information may be sent from the eNB to the UE. This information may either be in the form of a request or in the form of a notification. If the information is in the form of a request, the receiving entity will either allow or refuse the request.

In step S3, the eNB and/or the UE is configured to control the LTE transmissions to be outside the unscheduled period.

In one embodiment, the UE makes the decision by itself as to the unscheduled period, including its timing and optionally its start time. In another embodiment, the UE informs the eNB of the unscheduled period including its timing and optionally its start time. However the eNB makes the actual decision and will confirm the request by sending back the MAC CE to the UE.

In one modification, the MAC CE is configured to cause the activation of a timer. The length of time for which the timer is activated is controlled by the timer. The MAC CE may either define the actual length of time for which the timer is activated or may identify one or more predefined time options. When the timer expires, the unscheduled period is ended. In one embodiment, the time is activated in accordance with the start time information, that is at the start time.

In one embodiment, instead of defining the unscheduled period, additionally or alternatively the scheduled period is defined.

In embodiments, dynamic patterns can be scheduled in a reliable manner

It should be appreciated that in some embodiments, there may only be two different receivers which interfere with one another. In alternative embodiments, more than three such devices may be provided. The various different frequency bands are given by way of example only and other embodiments may have different or additional interfering frequencies.

The required data processing apparatus and functions of a base station apparatus, a communication device, a relay, and any other appropriate station may be provided by means of one or more data processors. The described functions at each end may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

It is noted that whilst embodiments have been described in relation to communications system such as those based on the LTE-Advanced (LTE-A) systems and 3GPP based systems, similar principles can be applied to other communication systems. Non-limiting examples of other communication systems include those based on the WCDMA and HSPA. Therefore, although certain embodiments were described above by way of example with reference to certain exemplifying architectures for wireless networks, technologies and standards, embodiments may be applied to any other suitable forms of communication systems than those illustrated and described herein. For example the eNB may be replaced in other embodiments by any suitable radio access node.

It should be appreciated that the interference scenarios give are by way of example and there may be additional and/or alternative interference scenarios between the different radio technologies.

Different embodiments are described above. Two or more embodiments may be combined. Parts of two or more embodiments may be combined.

It is also noted herein that while the above describes exemplifying embodiments of the invention, there are several variations and modifications which may be made to the disclosed solution without departing from the spirit and scope of the present invention.

1-42. (canceled)

43. A method comprising:
determining an unscheduled period in which a user equipment is configured to utilise a radio frequency different to a wireless cellular communication; and
providing a message comprising length information indicating a length of said unscheduled period.

44. A method as claimed in claim 43, wherein said message comprises a media access control control element providing said length information.

45. A method as claimed in claim 43, wherein said length information comprises a number of subframes.

46. A method as claimed in claim 43, wherein said length information identifies one of a plurality of predefined lengths.

47. A method as claimed in claim 43, wherein said message comprises a request for said unscheduled period.

48. A method as claimed in claim 47, comprising starting said unscheduled period responsive to information granting said request.

49. A method as claimed in claim 43, wherein said message comprises cell information, in the case of carrier aggregation, indicating cells to which said unscheduled period applies.

50. An apparatus comprising at least one processor, and at least one memory including computer program code, wherein the at least one memory and the computer program code are configured, with the at least one processor, to:
determine an unscheduled period in which a user equipment is configured to utilise a radio frequency different to a wireless cellular communication; and
provide a message comprising length information indicating a length of said unscheduled period.

51. Apparatus as claimed in claim 50, wherein said message comprises a media access control control element providing said length information.

52. Apparatus as claimed in claim 50, wherein said length information comprises a number of subframes.

53. Apparatus as claimed in claim 50, wherein said length information identifies one of a plurality of predefined lengths.

54. Apparatus as claimed in claim 50, wherein said message comprises a request for said unscheduled period.

55. Apparatus as claimed in claim 54, wherein the at least one memory and the computer program code are configured, with the at least one processor, to start said unscheduled period responsive to information granting said request.

56. Apparatus as claimed in claim 50, wherein said message comprises cell information, in the case of carrier aggregation, indicating cells to which said unscheduled period applies.

57. A user equipment comprising the apparatus as claimed in claim 50.

58. A base station comprising the apparatus as claimed in claim 50.

59. A computer program comprising program code means adapted to perform the steps of claim 43 when the program is run on a data processing apparatus.
